(19) United States
(12) Patent Application Publication
(10) Pub. No.: US 2012/0007382 A1
(43) Pub. Date: Jan. 12, 2012

(54) Tail gate covering for a dump truck and method of use

(76) Inventors: Michael F. Keck, Mapelewood, MO (US); Kennth Petters Petters, Villa Ridge, MO (US)

(21) Appl. No.: 12/658,296

(22) Filed: Feb. 9, 2010

(51) Int. Cl. B60P 7/04

(52) U.S. Cl. 296/100.16

(57) ABSTRACT

The comprises a tail gate cover for the intersection of a truck tail gate and the truck bed made from a sheet of extremely durable material of sufficient length to attach underneath the truck bed and wrap around and cover the lower portion of the tail gate. The material may be of sufficient width to wrap around the edges of the dump bed of the truck. The bottom of the protective tail gate cover maybe reinforced so it can be attached to the underside of the truck bed. The top of the tail gate covering can be reinforced so it holds it shape against the tailgate of the truck to be sufficiently secured so that no portion of goods or material can become dislodged and fall from the vehicle through the intersection of a truck tail gate and the truck bed while being transported or carried.

### BACKGROUND OF THE INVENTION

This invention relates generally to a cover for rear end of a dump truck and more particularly to a tail gate cover for gap between the tail gate and the bottom of a dump truck bed.

For years there have been “Tarp Laws” in place requiring all motor vehicles, and every trailer and semitrailer operating upon the public highways and carrying goods and material or farm products which may reasonably be expected to become dislodged and fall from the vehicle, trailer or semitrailer as a result of wind pressure or air pressure and/or by movement of the vehicle, trailer or semitrailer shall have a cover or be sufficiently secured so that no portion of such goods or material can become dislodged and fall from the vehicle, trailer or semitrailer while being transported or carried. Trucks with loose loads like gravel in a dump truck must be covered with a tarp so the contents of the truck will not become dislodged and fall from the truck and become a nuisance or a danger to other vehicles on the road. With out a tarp over the top of the load, debris would be blown from the load to the highway below causing danger to vehicles following the truck. After the laws went into effect the problem was somewhat relieved but not totally. Gravel or other loose loads were still being dropped to the highway, bouncing up to break windshields or damaging following vehicles on the highway.

It has been found that after a dump truck hauls a few loads; the hinged flap type tailgate does not close tight enough to prevent gravel or other material from working through the interface especially with the shaking and bouncing of normal highway driving. The particles that slip through the cracks fall to the highway and bounce into other vehicles. The tarp on top of the load has no effect on the gravel that slips out of the tailgate.

It is to object of this invention to solve this problem.

### BRIEF DESCRIPTION OF THE DRAWINGS

FIG. 1 is a depiction of a currently legal dump truck bed with the tarp in place.

FIG. 2 is a view of the tail gate covering

FIG. 3 is a depiction of the dump truck bed of FIG. 1 with the tail gate covering installed.

FIG. 4 is a depiction of the dump truck bed of FIG. 3 dumping its load and the tail gate covering tucked under the dump truck bed.

FIG. 5 is a depiction of the dump truck bed of FIG. 3 dumping its load and the tail gate covering released from underneath the dump truck bed.

FIG. 6 is a view of an alternative embodiment of the tail gate covering.

FIG. 7 is a depiction of the dumb truck bed of FIG. 1 with the alternative embodiment of the tail gate covering installed.

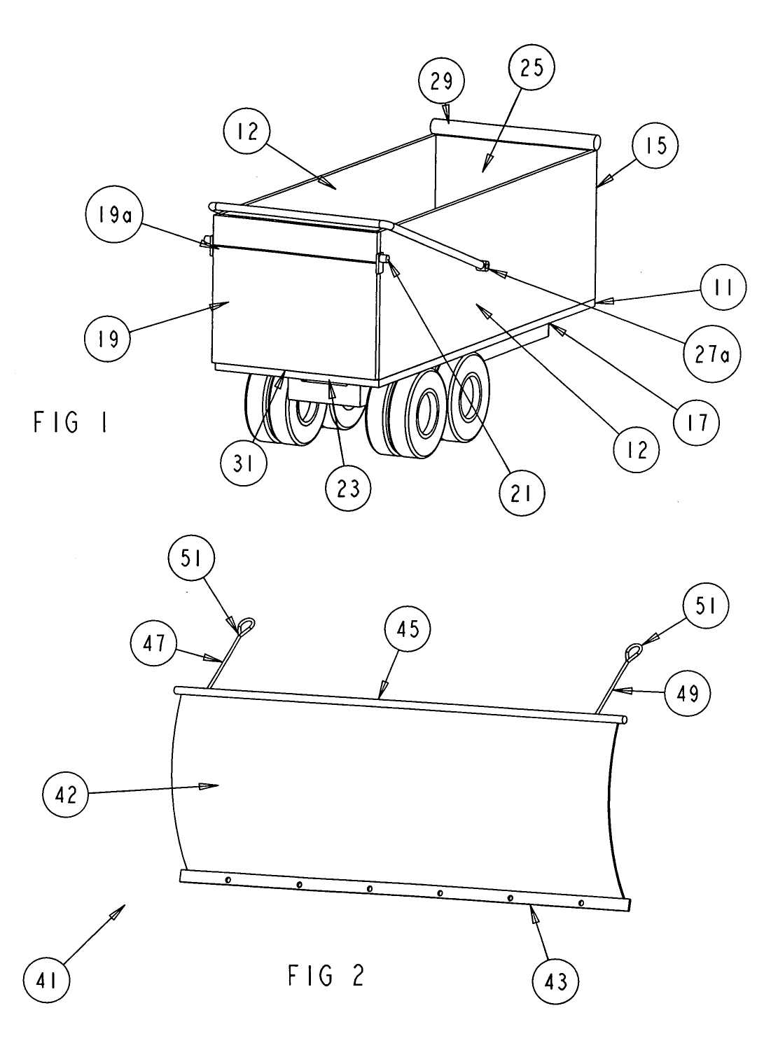

The attachment means may be to with very strong magnets, hooks, bolts or any other attachment devices to releasably or permanently secure the bottom of the tail gate covering 41 to the underside of the dump truck bed bottom 17. Tail gate covering 41 is then positioned so that it covers the lip of shoot 23, interface area 31 and tailgate bottom 19b with the securing devices 51 attached to the tail gate 19 or in the alternative to the sides 12 of dump truck bed 11.

When the operator gets to the dump site he may tuck the tail gate covering 41 underneath the dump truck bed bottom 17, by releasing securing devices 51 from the tail gate 19, dropping the top of tail gate covering 51, moving it past shoot 23 and reattaching securing devices 51 to either the attachment point of tail gate covering bottom 43 or to an attachment point 53 on the side of the dump truck bed 12; thus allowing the tail gate covering to be safely tucked away with out interfering with the unloading of the dump truck.

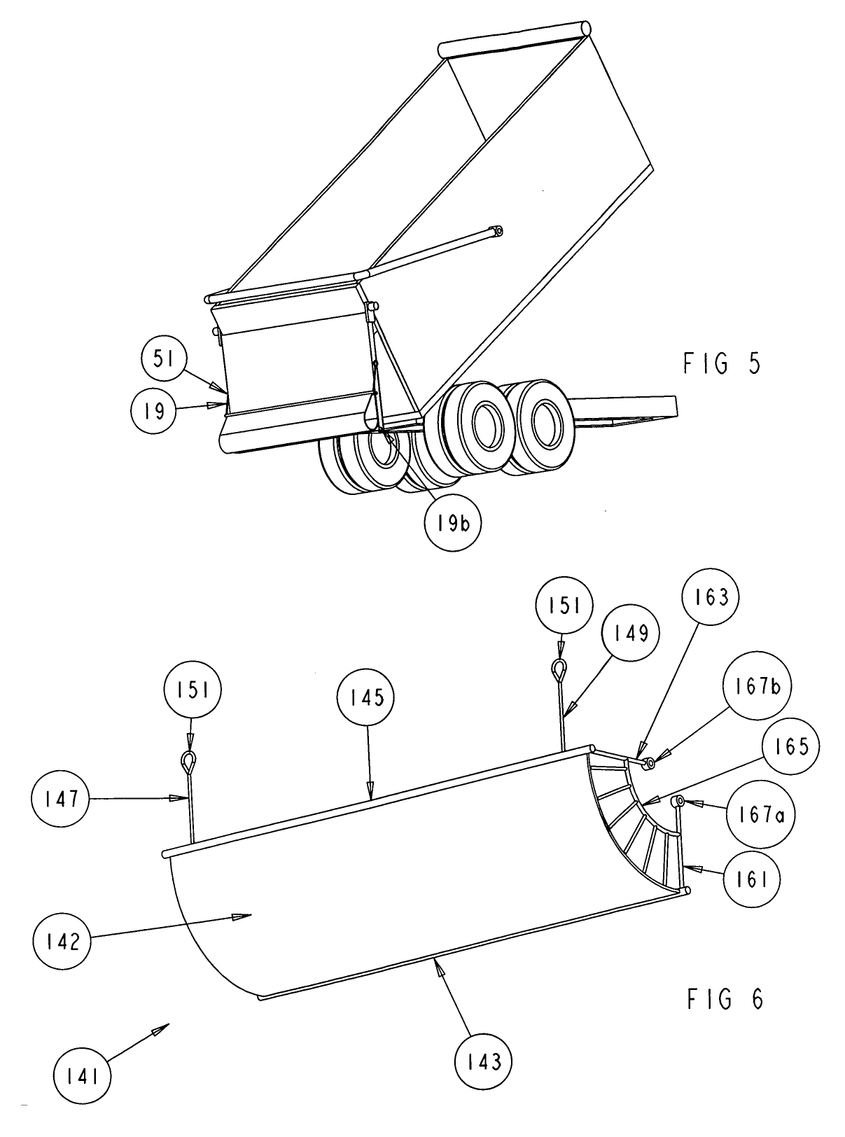

FIG. 5 shows the tail gate covering 51 released from underneath the truck bed 17 and folded over the tail gate bottom 19b and attached at the same point of attachment as securing devices 51 on the outside of tail gate 19. Again, in this position the tail gate covering is safely out of the way and does not interfere with the dumping of the load form the bed of the dump truck.

Referring now to FIG. 6 is shown an alternative tail gate covering 141, of the present invention in its alterative embodiment. Tail gate covering 141 is comprised of a mesh of open weave material similar 142 to that used for tarp. Tail gate covering 141 has a reinforced bottom 143 and a reinforced top 145. Cables 147 and 149 run from reinforced bottom 143 past top reinforcement 145 and are terminated with securing devices 151. In an alternative embodiment cable 147 can run from the top reinforcement 145 to bottom reinforcement 143 through bottom reinforcement 143 and back up to and past top reinforcement 145. It is also possible to have no cables or reinforcement at all. Tail gate covering 141 is of sufficient width to span the total of dump truck bed 11. Tail gate covering 141 has a securing device 163 preferably a cable that passes through the outer edge 165 of pleated section 161 that terminate in securing devices 167a and 167b.

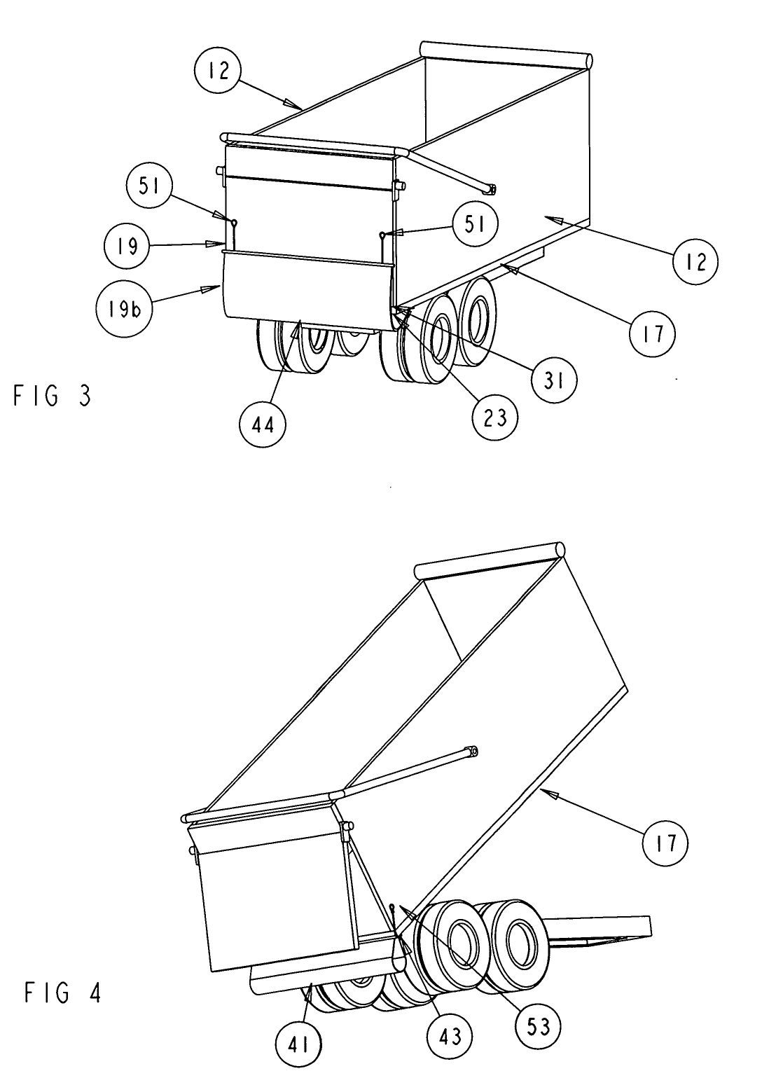

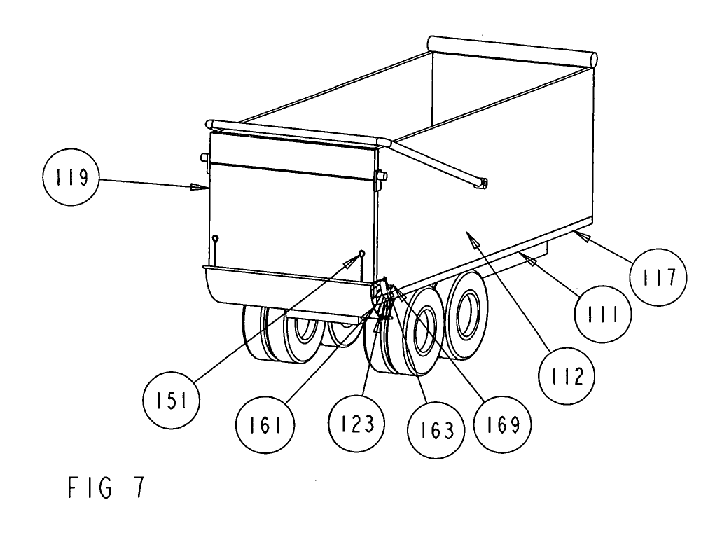

Referring now to FIG. 7 showing the alternative embodiment where in tail gate covering 141 is releasably or permanently attached to the underneath side of dump truck bed 111. The attachment means 143 may be to with very strong magnets, hooks, bolts or any other attachment devices to releasably or permanently secure the bottom of the tail gate covering 141 to the underside of the dump truck bed 111 bottom 117. Tail gate covering 141 is then positioned so that it covers the lip of shoot 123 (not shown), interface area 131 (not shown) and tailgate bottom 119b (not shown) with the securing devices 151 attached to the tail gate 119, pleated area 161 is wrapped around truck bed 111 and secured to truck bed 111 sides 112 at sacrament point 169 by securing devices 167a and 167b making sure that outer edge 165 of pleated section 161 is parallel to dump truck sides 112. Obviously when the operator is ready to dump the load the tail gate covering 141 may be stowed either underneath the truck bed 111 or on tail gate 119 as depicted in FIG. 3 and FIG. 5 for tail gate covering 41.

It will be seen that the object set forth above, among those made apparent from the preceding description, are efficiently attained and since certain changes may be made and carrying out the above method and in the construction set forth without departing from the spirit and scope of the invention, it is intended that all matter contained in the above description and in the accompanying drawings shall be interpreted as illustrative and not in a limiting sense.

When introducing elements of the mechanism here in, the articles “a”, “an”, “the” and “said” are intended to mean that there are one or more of the elements. The terms “comprising”, “including” and “having” and variations thereof are intended to be inclusive and mean that there may be additional elements other than the listed elements. Moreover, the use of “upward”, “downward”, “top” and “bottom” and variations of these terms or the use of other directional and orientation terms, is made for convenience, but does not require any particular orientation of the components.

It is also to be understood that the following claims are intended to cover all of the generic and specific features of the invention herein described and all statements to the scope of the invention which as a matter of language, might be said to fall there between.

What is claimed is:

1. A protective cover for the interface of a tailgate and bed of a dump truck or the like comprising:
a sheet of flexible material of sufficient length to attach underneath the truck bed by an attachment means,
the sheet of flexible material being wrapped around the rear portion of the truck bed to cover the interface of the tail gate and truck bed and to cover the lower portion of the tail gate,
having an attachment mean to hold the top portion of the sheet in position, to prevent goods and material carried in the truck bed from becoming dislodged and falling from the vehicle through the tail gate and truck bed interface.

2. The cover of claim 1 having at least one releasable attachment means.

3. The cover of claim 1 having an attachment means on the tail gate of the truck.

4. The cover of claim 1 having an attachment means on the side of the bed of the truck.

5. The cover of claim 1 where in the width of the sheet of flexible material approximates the width of the tail gate of the truck.

6. The cover of claim 1 where in the width of the sheet of flexible material is wider than the width of the tail gate of the truck so as to wrap around the sides of the truck bed on each side for a distance.

7. A method of preventing goods and materials from falling through the tail gate bed interface of a dump truck or the like by providing:
a sheet of flexible material of sufficient length to attach underneath the truck bed by an attachment means,
the sheet of flexible material being wrapped around the rear portion of the truck bed to cover the interface of the tail gate and truck bed and to cover the lower portion of the tail gate,
having an attachment mean to hold the top portion of the sheet in position.

8. The method of claim 7 using at least one releasable attachment means.

9. The method of claim 7 using an attachment means on the tail gate of the truck.

10. The method of claim 7 using an attachment means on the side of the bed of the truck.

11. The method of claim 7 wherein the width of the sheet of flexible material approximates the width of the tail gate of the truck.

12. The method of claim 7 wherein the width of the sheet of flexible material is wider than the width of the tail gate of the truck so as to wrap around the sides of the truck bed on each side for a distance.
